(19) United States
(12) Patent Application Publication
(10) Pub. No.: US 2009/0071194 A1
(43) Pub. Date: Mar. 19, 2009

(54) Manufacturing method of glass substrate for display

(76) Inventors: Hironori Takase, Moriyama-city (JP); Tatsuya Takaya, Sakata-gun (JP)

Correspondence Address: KUBOVCIK & KUBOVCIK, SUITE 1105, 1215 SOUTH CLARK STREET, ARLINGTON, VA, 22202, US

(21) Appl. No.: 12/289,795

(22) Filed: Nov. 4, 2008

Related U.S. Application Data
(62) Division of application No. 10/900,467, filed on Jul. 28, 2004.

(30) Foreign Application Priority Data
Jul. 29, 2003 (JP) 2003-202846
Jun. 23, 2004 (JP) 2004-184344

(51) Int. Cl. C03B 19/00; C03B 17/00

(52) U.S. Cl. 65/66

(57) ABSTRACT

A method of manufacturing a glass substrate for a display including the steps of:
preparing a glass raw material blended so as to adjust as, on the basis of mass percentage, SiO₂ 40-70%, Al₂O₃ 2-25%, B₂O₃ 0-20%, MgO 0-3.5%, CaO 0-15%, SrO 0-10%, BaO 0-2%, ZnO 0-10%, R₂O 0-25% (where R denotes at least one of Li, Na and K), As₂O₃ 0-0.4%, Sb₂O₃ 0-0.9%, and 0.1%<SnO₂<0.5%; and
melting the material and forming the substrate with contact with a platinum group element or a platinum group element alloy in at least a part of the melting and forming;
wherein the substrate has a surface area of 0.1 m² or more, a thickness of 2.5 mm or less, and surface projections of 2 pieces/m² or less, the surface not being ground, and wherein the substrate has 40 pieces/kg or less of stones of a platinum group element or a platinum group element alloy.

This application is a division of application Ser. No. 10/900,467, filed Jul. 28, 2004, and claims priority of Japanese Patent Application Nos. 2003-202846 and 2004-184344 filed Jul. 29, 2003, and Jun. 23, 2004, respectively, each of which is incorporated herein by reference.

### BACKGROUND OF THE INVENTION

1. Field of the Invention

The invention relates to a manufacturing method of a glass substrate for a display to be used for a liquid-crystal display or a plasma display.

2. Description of the Related Art

Conventionally, as a display substrate to be used for a liquid-crystal display or a plasma display, a rectangular glass substrate has been widely used.

Generally, a glass substrate for a display can be obtained by blending raw materials; melting the blended raw materials using melting facilities; forming the melt into a plate-like shape by a slot down draw method, an over flow down draw method, a float method, a roll out method or the like; and cutting the plate-like product (e.g., Japanese Patent Laid-Open 2001-122637).

Additionally, for the purpose of stain prevention for the glass, the portions to be brought into contact with the molten glass in the production facilities are made of a platinum group element or a platinum group element alloy, or are coated with a platinum group element or a platinum group element alloy in many cases.

With respect to an obtained glass substrate, conventionally, the substrate is ground to remove undulations and foreign glass phase existing in the glass substrate surface. However, if grinding is carried out, it causes a problem of production cost up. Further, in recent years, along with the advancement in high fineness and precision of a display, ultra small scratches on the glass surface by grinding become challenging concerns to be solved.

Accordingly, melting techniques and forming techniques have been improved to a further extent to suppress generation of undulations and glass phases and, as a result, it is made possible today to obtain a flat glass substrate without surface grinding.

However, there sometime occurs a trouble in an unground glass substrate that patterns are disconnected or short-circuited in a film formation step carried out thereafter.

### SUMMARY OF THE INVENTION

The object of the present invention is to provide a glass substrate with a high grade of the surface where circuit disconnection or short circuit hardly takes place even if it is not ground, and to provide a manufacturing method thereof.

Based on the results of various investigations, the present inventors have found that projections attributed to stones (deposited seeds) of platinum group elements cause disconnection of patterns and have proposed the invention.

That is, the invention provides a glass substrate for a display, having a surface area of 0.1 m² or more and a thickness of 2.5 mm or less and to be used for a display, wherein the glass substrate has surface projections of 2 pcs/m² or less, and the surface is not ground.

The invention also provides a manufacturing method of a glass substrate for a display, involving contact of glass with a platinum group element or a platinum group element alloy in at least a part of the manufacturing process, wherein inverse potential is applied from the outside so as to cancel the electromotive force generated by the contact of the glass with the platinum group element or the platinum group element alloy.

### BRIEF DESCRIPTION OF THE DRAWINGS

FIG. 1 is an explanatory view showing a schematic figure of a continuously melting furnace;

FIG. 2 is an explanatory view showing a cross-sectional view of a continuously melting furnace; and

FIG. 3 is an explanatory view showing application of inverse potential to a stirrer tube

### DESCRIPTION OF THE PREFERRED EMBODIMENTS

The causes for formation of projections in a glass substrate are supposed as follows.

In the case a platinum group element or a platinum group element alloy is used for a melting furnace or a forming apparatus, it is taken in the molten glass and forms platinum group element stones. At the time of forming the molten glass into a glass substrate, the molten glass is extended into a prescribed thickness; however, the platinum group element stones existing in the glass are solid and therefore scarcely extended. Accordingly, the portions where the platinum group element stones exist have a thickness increased to the extent that the thickness of the platinum group element stones is not made thin. The increase of the thickness is finally moderated owing to the viscous fluidity and elongation of glass in the surrounding of the platinum element stones. However, in the case the platinum group element stones exist near the glass substrate surface, since the amount of the glass in the surrounding of the platinum group element is small, the glass is solidified before the thickness is increased to result in easy appearance of the platinum group element stones as projections in the glass substrate surface. Moreover, since such glass with a high viscosity to be used for a glass substrate for a display is hardly extended, the above-mentioned phenomenon easily takes place. With respect to the glass for a plasma display, the temperature of the molten glass having a viscosity equivalent to 10⁴ dPa·s is 1,120° C. or more and, with respect to the glass for a liquid crystal display, the temperature of the molten glass having a viscosity equivalent to 10⁴ dPa·s is 1,200° C. or more. The projections in the glass substrate surface formed in such a manner lead to disconnection and short circuit of patterns in the film formation step, resulting in display defects.

The glass substrate tend to be made larger and thinner, and if the glass substrate is made to have a larger surface area or a thin thickness, the probability of the appearance of the projections in the glass substrate surface is increased and the ratio of qualified products is sharply decreased. Accordingly, to decrease the projections brings great advantages in large glass substrate manufacture. For example, it is particularly advantageous in the case the glass substrate has a surface area of 0.1 m² or more (practically, 320×420 mm or more glass substrate size), more preferably 0.5 m² or more (practically, 630×830 mm or more glass substrate size), furthermore preferably 1.1 m² or more (practically, 950×1,150 mm or more glass substrate size), even more preferably 2.3 m² or more (practically, 1,400×1,700 mm or more glass substrate size), even more preferably 3.5 m² or more (practically, 1,750×2,050 mm or more glass substrate size), and even more preferably 4.8 m² or more (practically, 2,100×2,300 mm or more glass substrate size). Also, it is particularly advantageous in the case the glass substrate has a thickness of 2.5 mm or less, more preferably 1.2 mm or less, furthermore preferably 0.8 mm or less, and even more preferably 0.5 mm or less.

According to the findings of the present inventors, since the glass substrate for display of the invention has 2 pcs/m² or less of projections in the glass substrate surface, no pattern disconnection of short circuit occurs in the film formation step and display defects owing to them can be suppressed. Further, since elimination of the projections makes grinding no need, a glass substrate with a high surface grade can be obtained. The number of projections in the glass substrate surface is preferably 1 pcs/m² or less, more preferably 0.4 pcs/m² or less, furthermore preferably 0.25 pcs/m² or less, and even more preferably 0.2 pcs/m² or less.

To suppress the projections in the glass substrate surface to 2 pcs/m² or less, the platinum group element stones which are causes of the projections should be suppressed preferably to 40 pcs/kg or less, more preferably 30 pcs/kg or less, furthermore preferably 20 pcs/kg or less, even more preferably 10 pcs/kg or less, and even more preferably 5 pcs/kg or less.

Here, the word “projection” means the portion with 1 μm or more in height difference (the height of the projection from the tip end of the projection to the glass substrate surface when inspection of 1,000 μm is carried out by a surface roughness meter. Also, the phrase “the platinum element stone” means that those with the maximum diameter of 3 μm or more.

The following can be supposed as one of the causes of the generation of the platinum element stones. A platinum group element or a platinum group element alloy used in a melting furnace, a forming apparatus or a stirring apparatus is electrochemically oxidized to be a platinum group element ion or a platinum group element oxide. The produced platinum group element ion or a platinum group element oxide is taken in glass. Since the platinum group element ion or a platinum group element oxide taken in the glass is unstable, it turns back to metal again and is precipitated in form of a platinum element stone in the glass. Therefore, in order to lessen the platinum group element stones in the glass substrate, it is required to suppress the oxidation reaction of the platinum group element or the platinum group element alloy.

The oxidation reaction of the platinum group element or the platinum group element alloy is caused by electromotive force generated by contact of molten glass with different composition and temperature with the platinum group element or the platinum group element alloy. Further, since the oxidation reaction and the reduction reaction occur simultaneously, if oxidation reaction of the platinum group element or the platinum group element alloy occurs, the reduction reaction takes place in the glass. Therefore, it is supposed that if the reduction reaction is prevented in the glass, the oxidation reaction of the platinum group element can be suppressed.

To suppress the oxidation reaction of the platinum group element or the platinum group element alloy, for example, it may be carried out to suppress electromotive force generation at the sites where the electromotive force is to be generated by applying inverse potential, or to add and melt 0.01 mass % or more of SnO₂ partially converted into SnO easier to be oxidized in glass than the platinum group element, or to add and melt a predetermined amount or less of As₂O₃ or Sb₂O₃, more particularly 0.4 mass % or less of As₂O₃ and 3 mass % or less of Sb₂O₃, which are easy to be reduced in the glass components.

To more effectively suppress the oxidation reaction of the platinum group element or the platinum group element alloy, these methods are preferably combined with one another.

The practical composition of the glass substrate for a display of the invention may be properly determined depending on the use in consideration of the chemical resistance, thermal shrinkage, melting property, thermal expansion coefficient and the like. The preferable composition range is, on the basis of mass percentage, 40 to 70% of SiO₂, 2 to 25% of Al₂O₃, 0 to 20% of B₂O₃, 0 to 10% of MgO, 0 to 15% of CaO, 0 to 10% of SrO, 0 to 30% of BaO, 0 to 10% of ZnO, 0 to 25% of R₂O (where R denotes at least one of Li, Na and K), 0 to 0.4% of As₂O₃, 0 to 3% of Sb₂O₃, 0.01 to 1% of SnO₂. Hereinafter, % represents all mass %.

The reasons for the above-defined limit of the glass composition in the invention are as follows.

SiO₂ is a component to be a former of a glass network and has an effect to improve the acid resistance of glass and to suppress the thermal shrinkage of the glass substrate by increasing the strain point of the glass. If the content is increased, the high temperature viscosity of the glass is increased and the melting property is deteriorated and thus devitrification stones of cristobalite tend to be precipitated. On the other hand, if the content is decreased, the acid resistance and the strain point of glass tend to be decreased. If the content of SiO₂ is 40 to 70%, it tends to become easy to obtain a glass substrate with a high acid resistance and a small thermal shrinkage. A preferable range is 50 to 67% and a more preferable range is 57 to 64%.

Al₂O₃ is a component to increase the strain point of glass or suppress the precipitation of devitrification stones of cristobalite. If the content is increased, the buffered-hydrochloric-acid proof of the glass tends to be deteriorated or the liquid phase temperature tends to be high, resulting in deterioration of the formability of the glass. On the other hand, if the content is decreased, the strain point of the glass tends to be low. If the content of Al₂O₃ is in a range of 2 to 25%, it becomes easy to obtain a glass substrate with a low liquid phase temperature. A preferable range is 10 to 20% and a more preferable range is 14 to 17%.

B₂O₃ is a component working as a flux to decrease the viscosity of the glass and improve the melting property. If the content is increased, the stain point of the glass tends to be decreased and the acid resistance tends to be deteriorated. On the other hand, if the content is decreased, the function as a flux becomes insufficient and the melting property tends to be decreased. If the content of B₂O₃ is in a range of 0 to 20%, the above-mentioned effects are easy to obtain. A preferable range is 5 to 15% and a more preferable range is 7.5 to 11%.

MgO is a component for decreasing only the high temperature viscosity without decreasing the stain point of the glass and thus improving the melting property of the glass. If the content is increased, devitrification stones of enstatite tend to be easily precipitated. Further, the buffered-hydrofluoric-acid proof is deteriorated, the glass substrate surface is corroded, reactive products adhere to the glass substrate surface, and thus the glass substrate easily becomes opaque. On the other hand, if the content of MgO is 10% or less, the melting property of the glass can be improved without decreasing the buffered-hydrofluoric-acid proof. A preferable range is 0 to 5% and a more preferable range is 0 to 3.5%.

CaO is a component for decreasing only the high temperature viscosity without decreasing the stain point of the glass and thus remarkably improving the melting property of the glass. If the content is increased, the buffered-hydrofluoric-acid proof tends to be deteriorated. On the other hand, if the content of CaO is 15% or less, the melting property of the glass can be improved without decreasing the buffered-hydrofluoric-acid proof. A preferable range is 0 to 12% and a more preferable range is 3.5 to 8%.

SrO is a component for improving chemical resistance and devitrification resistance of glass. If the content is increased, the density and the thermal expansion coefficient of the glass tend to be increased and the melting property tends to be decreased. If the content of SrO is 10% or less, the above-mentioned effects are easily obtained. A preferable range is 0 to 8% and a more preferable range is 0.5 to 8%.

Similarly to SrO, BaO is a component for improving chemical resistance and devitrification resistance of glass. If the content is increased, the density and the thermal expansion coefficient of the glass tend to be increased and the melting property tends to be deteriorated. If the content of BaO is 30% or less, the above-mentioned effects are easily obtained. A preferable content is 0 to 20% and a more preferable content is 0 to 10%.

ZnO is a component for improving buffered-hydrofluoric acid proof and the melting property of glass. If the content is increased, the devitrification resistance and the strain point of the glass tend to be decreased. If the content of ZnO is 10% or less, the above-mentioned effects can be obtained. A preferable range is 0 to 5% and a more preferable range is 0 to 1%.

R₂O (where R denotes at least one of Li, Na and K) is a component for decreasing the viscosity of glass and improving the melting property of the glass. If the content is increased, the stain point of the glass tends to be decreased. If the content of the alkali metal oxide is 25% or less in total, the above-mentioned effects are easy to obtain. A preferable range is 0 to 20%.

In the case the glass substrate for a display of the invention is used for a liquid crystal display, the glass to be used should be alkali-free glass. The reason for that is because in the case an alkali metal oxide is contained in the glass, the alkali component in the glass possibly deteriorates the characteristics of various kinds of films and TFT devices formed on the glass substrate. The “alkali-free” means the content of R₂O is 0.1 or less.

As₂O₃ is a clarifying component; however, it is a component considerably easy to be reduced. If the content is increased, the oxidation reaction of the platinum group element tends to be promoted greatly; therefore, platinum group element stones are easily precipitated in the glass. If the content of As₂O₃ is 0.4% or less, only the clarifying effect can be obtained without promoting the oxidation reaction of the platinum group element. A preferable content is 0.2% or less and a more preferable content is 0.05% or less.

Sb₂O₃ is a clarifying component; however, it is a component easy to be reduced. If the content is increased, the glass is reduced and oxidation reaction of the platinum group element tends to be promoted; therefore, platinum group element stones are easily precipitated in the glass. If the content of Sb₂O₃ is 3% or less, only the clarifying effect can be obtained without promoting the oxidation reaction of the platinum group element. A preferable content is 2% or less and a more preferable content is 1.5% or less.

SnO₂ is partially converted into SnO in the glass and is a component to be oxidized in place of the platinum group element and thereby to suppress oxidation reaction of the platinum group element and suppress precipitation of the platinum group element stones in the glass. Further, it is also a clarifying component and makes it possible to obtain foam-free glass even if the glass is difficult to be free from foams because of the decrease of the contents of As₂O₃ and Sb₂O₃. However, if the content of SnO₂ is too much, the glass tends to be devitrified. If the content is in a range of 0.01 to 1%, the above-mentioned effects are easy to obtain. A preferable range is 0.01 to 0.5% and a more preferable range is higher than 0.1% and less than 0.5%.

In the invention, besides the above-mentioned components, C1 and SO₃ may be added up to 0.5%, respectively, as clarifying agents.

Next, a manufacturing method of the glass substrate for a display of the invention will be described.

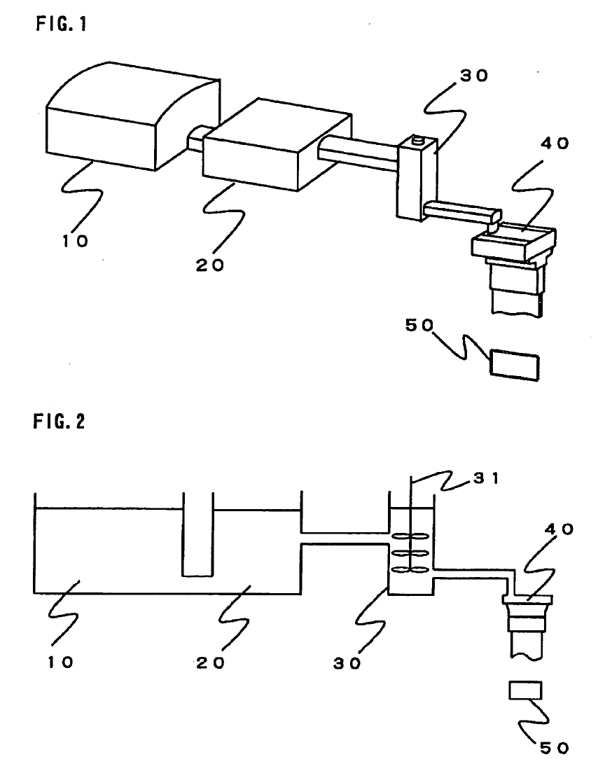

At first, glass raw materials are blended respectively in the above-mentioned glass composition ranges. Successively, the blended glass raw materials are loaded into a continuously melting furnace illustrated in FIG. 1 and FIG. 2 to melt the glass raw materials in a dissolution tank 10 and after being defoamed in a clarifying tank 20, the resulting molten glass is made even by rotating a stirrer 31 in a stirring tank 30, supplied to a formation apparatus 40, and after being formed into a plate-like shape, the formed molten glass is gradually cooled and cut to obtain a glass substrate 50.

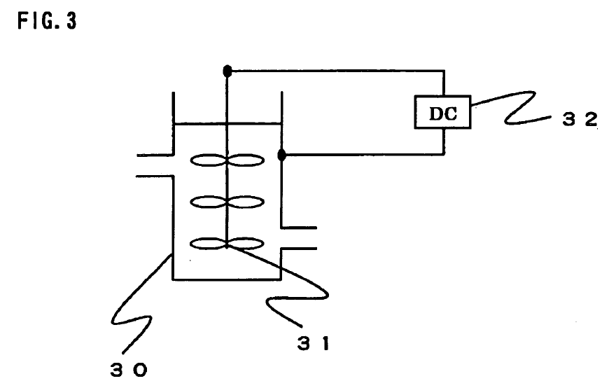

In the case there are points where electromotive force is generated because of the contact of the platinum group element or the platinum group element alloy with the molten glass, if inverse potential is applied to the points, the generation of the platinum group element stones can be effectively suppressed. For example, as shown in FIG. 3, in the stirring tank, the inverse potential is applied to the stirrer tube 30 so as to suppress the electromotive force to be generated in the high temperature melted substance in gaps between the stirrer 31 and the stirrer tube 30. Specifically, negative potential is applied to the stirrer 31 and positive potential is applied to the stirrer tube 30.

As the glass substrate formation method, there are a variety of the formation methods such as a slot down draw method, an overflow down draw method, a float method, a redraw method and the like, it is preferable to form the molten glass into the plate-like shape by the down draw method, particularly the overflow down draw method. The reason for that is because, unlike other formation methods, the overflow down draw method is a method involving no contact of the surface of the glass substrate with the forming body and the obtained glass substrate has the glass substrate surface free from polluted parts. Therefore, it becomes advantageous in the case of obtaining an unground glass substrate and ultra small scratches by grinding can be avoided.

In such a manner, even if it is not ground, the glass substrate for a display with a high surface grade can be obtained.

Hereinafter, a glass substrate for a display of the invention will be described in details with reference to examples.

Tables 1 and 2 show the examples of the invention (sample Nos. 1 to 13) and Table 3 show comparative examples (sample Nos. 14 to 16), respectively. Incidentally, “Pt stones” in Tables 1 to 3 shows platinum group element stones.

The invention should not be limited to the glass compositions described in these examples and may include other glass compositions if they are in the above-mentioned ranges.

TABLE 1

| | Example | | | | | |
|---|---|---|---|---|---|---|
| | 1 | 2 | 3 | 4 | 5 | 6 |
| Composition | | | | | | |
| (mass %) | | | | | | |
| SiO₂ | 59.65 | 59.75 | 59.75 | 59.65 | 59.65 | 59.50 |
| Al₂O₃ | 15.00 | 15.00 | 15.00 | 15.00 | 15.00 | 15.00 |
| B₂O₃ | 10.00 | 10.00 | 10.00 | 10.00 | 10.00 | 10.00 |
| MgO | — | — | — | 0.10 | — | — |
| CaO | 5.50 | 5.50 | 5.50 | 5.40 | 5.50 | 5.50 |
| SrO | 6.00 | 6.00 | 6.00 | 6.00 | 7.90 | 6.00 |
| BaO | 2.00 | 2.00 | 2.00 | 2.00 | 0.10 | 2.00 |
| ZnO | 0.50 | 0.50 | 0.50 | 0.50 | 0.50 | 0.50 |
| As₂O₃ | 0.05 | 0.20 | 0.40 | 0.05 | 0.05 | — |
| Sb₂O₃ | 0.90 | 0.80 | 0.70 | 0.90 | 0.90 | 1.00 |
| SnO₂ | 0.20 | 0.15 | 0.10 | 0.20 | 0.20 | 0.30 |
| Cl₂ | 0.20 | 0.10 | 0.05 | 0.20 | 0.20 | 0.20 |
| Projection | 0.08 | 0.13 | 0.32 | 0.10 | 0.09 | 0.08 |
| (pcs/m²) | | | | | | |
| Pt stone | 4.5 | 8.5 | 30.0 | 5.9 | 5.3 | 4.2 |
| (pcs/kg) | | | | | | |

TABLE 2

| | Example | | | | | | |
|---|---|---|---|---|---|---|---|
| | 7 | 8 | 9 | 10 | 11 | 12 | 13 |
| Composition | | | | | | | |
| (mass %) | | | | | | | |
| SiO₂ | 59.85 | 59.65 | 59.75 | 59.75 | 59.10 | 59.10 | 63.65 |
| Al₂O₃ | 15.00 | 15.00 | 15.00 | 15.00 | 15.00 | 15.00 | 16.00 |
| B₂O₃ | 10.00 | 10.00 | 10.00 | 10.00 | 10.00 | 10.00 | 10.00 |
| MgO | — | — | — | — | — | — | — |
| CaO | 5.50 | 5.50 | 5.50 | 5.50 | 5.50 | 5.50 | 7.50 |
| SrO | 6.00 | 6.00 | 6.00 | 6.00 | 6.00 | 6.00 | 1.00 |
| BaO | 2.00 | 2.00 | 2.00 | 2.00 | 2.00 | 2.00 | 0.50 |
| ZnO | 0.50 | 0.50 | 0.50 | 0.50 | 0.50 | 0.50 | — |
| As₂O₃ | 0.20 | 0.05 | 0.20 | 0.40 | 0.20 | 0.40 | 0.05 |
| Sb₂O₃ | 0.80 | 0.90 | 0.80 | 0.70 | 0.80 | 0.70 | 0.90 |
| SnO₂ | 0.15 | 0.20 | 0.15 | 0.10 | 0.20 | 0.20 | 0.20 |
| Cl₂ | — | 0.20 | 0.10 | 0.05 | — | — | 0.20 |
| Projection | 0.13 | 0.07 | 0.11 | 0.21 | 0.11 | 0.23 | 0.09 |
| (pcs/m²) | | | | | | | |
| Pt stone | 8.9 | 3.2 | 5.9 | 20.9 | 6.1 | 22.5 | 4.9 |
| (pcs/kg) | | | | | | | |

TABLE 3

| Composition | Comparative Example | | |
|---|---|---|---|
| (mass %) | 14 | 15 | 16 |
| SiO₂ | 58.90 | 57.40 | 59.10 |
| Al₂O₃ | 15.00 | 15.00 | 15.00 |
| B₂O₃ | 10.00 | 10.00 | 10.00 |
| MgO | — | — | — |
| CaO | 5.50 | 5.50 | 5.50 |
| SrO | 6.00 | 6.00 | 6.00 |
| BaO | 2.00 | 2.00 | 2.00 |
| ZnO | 0.50 | 0.50 | 0.50 |
| As₂O₃ | 1.00 | 0.50 | 1.00 |
| Sb₂O₃ | 0.90 | 3.10 | 0.90 |
| SnO₂ | 0.20 | — | — |
| Cl₂ | — | — | — |
| Projection | 3.34 | 2.51 | 9.00 |
| (pcs/m²) | | | |
| Pt stone | 150.0 | 86.0 | 500.0 |
| (pcs/kg) | | | |

The respective samples shown in the Tables 1 to 3 were prepared as follows.

At first, each raw material batch blended so as to adjust the glass composition as shown in Tables 1 to 3 was melted in a continuously melting furnace equipped with a stirrer and a stirrer tube using a platinum alloy. Successively, the melted mixture was formed into a glass substrate with a thickness of 0.7 mm by an overflow down draw method and the substrate was cut into 360 mm×460 mm.

Incidentally, with respect to the sample Nos. 8 to 10, inverse potential was applied to the stirrer tube in the stirring tank.

Each sample obtained in such a manner was subjected to the measurement of the numbers of the projections and the Pt stones.

Being made clear from Tables 1 to 3, with respect to the sample Nos. 1 to 13 of examples, the number of Pt stones in each glass substrate was as low as 30.0 pcs/kg or less and the number of projections of each glass substrate surface was as low as 0.32 pcs/m² or less.

On the other hand, the number of Pt stones of each of the sample Nos. 14 to 16 of the comparative example was as high as 86.0 pcs/kg or more and the number of projections of each glass substrate surface was as high as 2.51 pcs/m² or more.

The number of projections of the glass substrate surface was calculated by carrying out rough inspection with eyes based on the reflected light in the case of radiating light of a fluorescent lamp to each glass substrate in a dark room; thereafter measuring the height of each projection by using a contact type roughness meter; counting the number of projections with 1 μm or more in height difference (the projection height) between the tip ends of the projections and the glass substrate surface when the inspection of 1,000 μm distance was carried out; and calculating the number of projections in 1 m² from the counted number.

The number of Pt stones was calculated by carrying out rough inspection with eyes by radiating light of a sodium lamp to a side face of each glass substrate in a dark room; thereafter counting the number of Pt stones with 3 μm or more maximum diameter by using a microscope; and calculating the number of Pt stones per 1 kg from the counted number.

Since the number of platinum group element stones in a glass substrate for a display of the invention is small, a glass substrate with a high surface grade with a suppressed number of projections and having a high surface grade can be obtained even if the glass substrate is not ground. Therefore, the substrate is useful as the glass substrate for a display.

What is claimed is:

1. A manufacturing method of a glass substrate for a display comprising the steps of:
preparing a glass raw material blended so as to adjust as, on the basis of mass percentage, 40 to 70% of SiO₂, 2 to 25% of Al₂O₃, 0 to 20% of B₂O₃, 0 to 3.5% of MgO, 0 to 15% of CaO, 0 to 10% of SrO, 0 to 2% of BaO, 0 to 10% of ZnO, 0 to 25% of R₂O (where R denotes at least one of Li, Na and K), 0 to 0.4% of As₂O₃, 0 to 0.9% of Sb₂O₃, and higher than 0.1% and less than 0.5% of SnO₂; and
melting said glass raw material and forming the glass substrate with contact with a platinum group element or a platinum group element alloy in at least a part of the melting and forming;
wherein said glass substrate has a surface area of 0.1 m² or more, a thickness of 2.5 mm or less, and surface projections of 2 pieces/m² or less, the surface not being ground, and wherein said glass substrate has 40 pieces/kg or less of stones of a platinum group element or a platinum group element alloy.

2. The manufacturing method according to claim 1, wherein the glass substrate is formed by a down draw formation method.
